(19) United States
(12) Patent Application Publication
(10) Pub. No.: US 2025/0167584 A1
(43) Pub. Date: May 22, 2025

(54) POWER CONVERTERS AND UNINTERRUPTIBLE POWER SUPPY (UPS) INCLUDING THE SAME

(71) Applicant: Eaton Intelligent Power Limited, Dublin 4 (IE)

(72) Inventors: Dan Liu, Shenzhen (CN); Lei Cao, Shenzhen (CN); Dawei Zheng, Shenzhen (CN); Huahong Ning, Shenzhen (CN); Yulong Hao, Shenzhen (CN)

(21) Appl. No.: 18/937,437

(22) Filed: Nov. 5, 2024

(30) Foreign Application Priority Data
Nov. 16, 2023 (CN) 202311537123.4

(51) Int. Cl. H02J 9/06; H02J 7/00

(52) U.S. Cl. CPC H02J 9/061; H02J 7/0063; H02J 7/0068; H02J 2207/20

(57) ABSTRACT

A power converter and a UPS including the same are provided. The power converter includes: a first power conversion module including a first and a second bridge arms, and a second power conversion module including a third and a fourth bridge arms, where first terminals of the first and second power conversion modules are configured to be capable of being electrically connected to a mains supply and/or a rechargeable battery, and second terminals are configured to be capable of being electrically connected to a DC bus; and a switch module, configured to enable the first terminals of the first and second power conversion modules to be selectively electrically connected to the mains supply and/or the rechargeable battery, where the first and second power conversion modules, and the switch module are configured to charge the rechargeable battery from the DC bus through the first and fourth bridge arms.

### CROSS-REFERENCE TO RELATED APPLICATION

This application claims priority to Chinese Patent Application No. 202311537123.4 filed Nov. 16, 2024, the content of which is hereby incorporated herein by reference in its entirety.

### TECHNICAL FIELD

The present inventive concept relates to the field of power supplies, and in particular, to power converter and an uninterruptible power supplies (UPSs) including the power converter.

### BACKGROUND

A uninterruptible power supply (UPS) is used to instantaneously switch to providing continuous power to a load from a backup power supply (e.g., a rechargeable battery) when a primary power supply (e.g., a municipal power grid) is not in a normal state, to protect the load from damage due to power interruption of the primary power supply. The UPS typically includes an AC-DC conversion module (rectifier) that converts an alternating current into a direct current, a DC-AC conversion module (inverter) that converts a direct current into an alternating current, a backup power supply, and a DC-DC conversion module (charger) that charges the backup power supply.

When the primary power supply fails, the UPS switches a system from operating with the primary power supply to operating with the backup power supply. When the primary power supply resumes operation, the UPS switches the system from operating with the backup power supply to operating with the primary power supply.

### SUMMARY

Therefore, the objectives of the present inventive concept are to reduce costs and optimize space, and a power converter is provided, including: a first power conversion module, including a first bridge arm and a second bridge arm, where a first terminal of the first power conversion module is configured to be capable of being electrically connected to a mains supply and/or a rechargeable battery, and a second terminal of the first power conversion module is configured to be capable of being electrically connected to a direct current bus; a second power conversion module, including a third bridge arm and a fourth bridge arm, where a first terminal of the second power conversion module is configured to be capable of being electrically connected to the mains supply and/or the rechargeable battery, and a second terminal of the second power conversion module is configured to be capable of being electrically connected to a direct current bus; and a switch module, configured to enable the first terminal of the first power conversion module and the first terminal of the second power conversion module to be selectively electrically connected to the mains supply and/or the rechargeable battery, where the first power conversion module, the second power conversion module, and the switch module are configured to charge the rechargeable battery from the direct current bus through the first bridge arm and the fourth bridge arm.

In the power converter according to the present inventive concept, the first power conversion module, the second power conversion module, and the switch module are configured to convert a first phase of the mains supply into a direct current through the second bridge arm and provide the direct current to the direct current bus, and convert a second phase of the mains supply into a direct current through the third bridge arm and provide the direct current to the direct current bus.

In the power converter according to the present inventive concept, the switch module includes a first switch assembly, a second switch assembly, a third switch assembly, and a fourth switch assembly that respectively correspond to the first bridge arm, the second bridge arm, the third bridge arm, and the fourth bridge arm and are separately configured to enable first terminals of the first bridge arm, the second bridge arm, the third bridge arm, and the fourth bridge arm to be selectively connected to the mains supply or the rechargeable battery.

In the power converter according to the present inventive concept, the first terminal of the first power conversion module includes a first sub-terminal and a second sub-terminal, and the first terminal of the second power conversion module includes a third sub-terminal and a fourth sub-terminal, where the first sub-terminal is electrically connected to the first switch assembly, the second sub-terminal is electrically connected to the second switch assembly, the third sub-terminal is electrically connected to the third switch assembly, and the fourth sub-terminal is electrically connected to the fourth switch assembly.

In the power converter according to the present inventive concept, the first bridge arm, the second bridge arm, the third bridge arm, and the fourth bridge arm each include an inductor, a first switching transistor, and a second switching transistor, where a first terminal of the first switching transistor and a second terminal of the second switching transistor constitute an output terminal of the bridge arm, a second terminal of the first switching transistor is electrically connected to a first terminal of the second switching transistor, a first terminal of the inductor is electrically connected to a node between the first switching transistor and the second switching transistor, and a second terminal of the inductor is electrically connected to a corresponding switch assembly.

In the power converter according to the present inventive concept, two capacitors connected in series with each other are separately disposed between a positive electrode and a negative electrode of the direct current bus, and a node between the two capacitors is grounded.

The power converter according to the present inventive concept further includes a third power conversion module, including a fifth bridge arm and a sixth bridge arm, where a first terminal of the third power conversion module is configured to be capable of being electrically connected to the mains supply, and a second terminal of the third power conversion module is configured to be capable of being electrically connected to the direct current bus.

The power converter according to the present inventive concept includes the following operating modes: a rectification mode, where the switch module is configured to enable the first sub-terminal, the second sub-terminal, the third sub-terminal, and the fourth sub-terminal to be electrically connected to the mains supply; and a rectification-charging mode, where the switch module is configured to enable the first sub-terminal and the fourth sub-terminal to be electrically connected to the rechargeable battery, and the second sub-terminal and the third sub-terminal to be electrically connected to the mains supply.

The present inventive concept further provides an uninterruptible power supply, including: the power converter according to the present inventive concept; an inverter, electrically connected to the direct current bus of the power converter; a rechargeable battery, whose charging terminal is electrically connected to the switch module of the power converter; and a DC-DC converter, configured to convert an output voltage of the rechargeable battery and then provide a converted voltage to the inverter.

The uninterruptible power supply according to the present inventive concept further includes a charger electrically connected to a charging terminal of the rechargeable battery.

Compared with the conventional technology, the power converter in the present inventive concept can improve a charging capability of the UPS and reduce costs and a volume of the UPS.

### BRIEF DESCRIPTION OF THE DRAWINGS

The following further describes the embodiments of the present inventive concept with reference to the accompanying drawings, where:

FIG. 1 is a schematic block diagram of a power converter according to some embodiments of the present inventive concept.

FIG. 2 is a circuit topology of a power converter according to some embodiments of the present inventive concept.

FIG. 3 shows a current loop of a power converter during inductor charging according to some embodiments of the present inventive concept.

FIG. 4 shows a current loop of a power converter during inductor discharging according to some embodiments of the present inventive concept.

FIG. 5 and FIG. 6 respectively show curves of battery voltages and inductor currents during charging with a small current and a large current in a simulation experiment.

FIG. 7 is a structural block diagram of an UPS according to some embodiments of the present inventive concept.

FIG. 8 is a structural block diagram of a UPS according to some embodiments of the present inventive concept.

### DETAILED DESCRIPTION

To make the objectives, technical solutions, and advantages of the present inventive concept clearer, the following further describes the present inventive concept in detail through the embodiments with reference to the accompanying drawings. It should be understood that the embodiments described herein are only used to explain the present inventive concept, and are not intended to limit the present inventive concept.

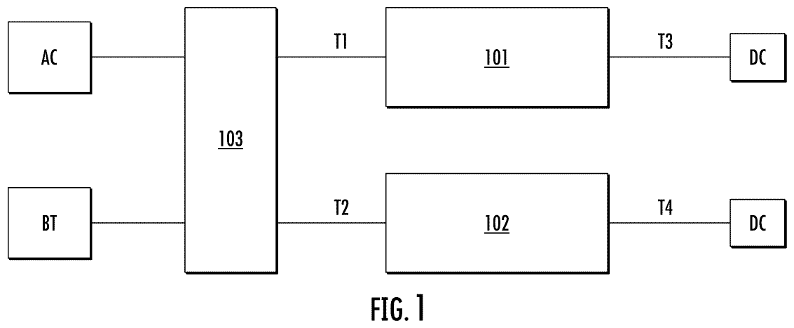

FIG. 1 shows a schematic block diagram of a power converter according to some embodiments of the present inventive concept. The power converter includes a first power conversion module 101, a second power conversion module 102, and a switch module 103. The switch module 103 is arranged between first terminals of the first power conversion module 101 and the second power conversion module 102 and a mains supply AC and a rechargeable battery BT, and is configured to enable the first terminal T1 of the first power conversion module 101 and the first terminal T2 of the second power conversion module 102 to be selectively electrically connected to the mains supply AC and/or the rechargeable battery BT. A second terminal T3 of the first power conversion module 101 is configured to be capable of being electrically connected to a direct current bus DC, and a second terminal T4 of the second power conversion module 102 is configured to be capable of being electrically connected to a direct current bus DC. Those skilled in the art can understand that the direct current buses connected to the terminals T3 and T4 may be the same direct current bus, or may be different direct current buses. Specifically, the first power conversion module 101 and the second power conversion module 102 each include two power conversion bridge arms. The first power conversion module 101, the second power conversion module 102, and the switch module 103 are configured to implement different operating modes, including a rectification mode, a charging mode, and a rectification-charging mode. Specifically, when the battery does not need to be charged, switch logic of the switch module 103 and operating logic of the power conversion modules 101 and 102 are controlled, so that both the first terminal T1 of the first power conversion module 101 and the first terminal T2 of the second power conversion module 102 draw power from the mains supply, respectively perform AC-DC conversion, and supply converted power to the terminals T3 and T4 which then supply power to a load. When the battery needs to be charged, the switch logic of the switch module 103 and the operating logic of the power conversion modules 101 and 102 are controlled, so that the rechargeable battery is charged from the direct current bus DC through a first bridge arm of the power conversion module 101 and a second bridge arm of the power conversion module 102. The direct current bus can be powered by the mains supply through a second bridge arm of the power conversion module 101 and a first bridge arm of the power conversion module 102.

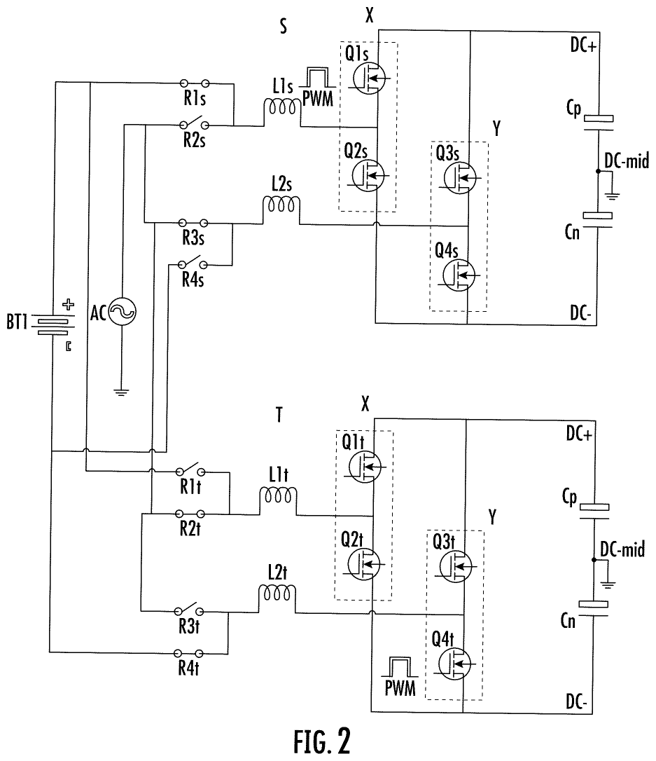

Refer to FIG. 2 which shows a circuit topology of a power converter according to some embodiments of the present inventive concept. The circuit topology includes a first phase S and a second phase T. The first phase S and the second phase T each include two bridge arms X and Y that are parallel to each other, and the first bridge arm X of the first phase S includes a first inductor L1s, a first switching transistor Q1s, and a second switching transistor Q2s, where a first terminal of the first switching transistor Q1s is electrically connected to a positive direct current bus DC+, a second terminal of the first switching transistor Q1s is electrically connected to a first terminal of the second switching transistor Q2s, a second terminal of the second switching transistor Q2s is electrically connected to a negative direct current bus DC−, a first terminal of the first inductor L1s is electrically connected to a node between the first switching transistor Q1s and the second switching transistor Q2s, a second terminal of the first inductor L1s is electrically connected to a positive electrode of a rechargeable battery BT1 through a first relay R1s and is also connected to a mains supply AC through a second relay R2s, a first capacitor Cp and a second capacitor Cn are connected in series between the positive direct current bus DC+ and the negative direct current bus DC−, and a node DC-mid between the first capacitor Cp and the second capacitor Cn is grounded. Similarly, the second bridge arm Y of the first phase S includes a second inductor L2s, a third switching transistor Q3s, and a fourth switching transistor Q4s, where a first terminal of the third switching transistor Q3s is electrically connected to the positive current bus DC+, a second terminal of the third switching transistor Q3s is electrically connected to a first terminal of the fourth switching transistor Q4s, a second terminal of the fourth switching transistor Q4s is electrically connected to the negative direct current bus DC−, a first terminal of the second inductor L2s is electrically connected to a node between the third switching transistor Q3s and the fourth switching transistor Q4s, and a second terminal of the second inductor L2s is electrically connected to the positive electrode of the rechargeable battery BT1 through a fourth relay R4s and is also electrically connected to the mains supply AC through a third relay R3s.

The second phase T has the same design as the first phase S. Specifically, the first bridge arm X of the second phase T includes a first inductor L1t, a first switching transistor Q1t, and a second switching transistor Q2t, where a first terminal of the first switching transistor Q1t is electrically connected to a positive direct current bus DC+, a second terminal of the first switching transistor Q1t is electrically connected to a first terminal of the second switching transistor Q2t, a second terminal of the second switching transistor Q2t is electrically connected to a negative direct current bus DC−, a first terminal of the first inductor L1t is electrically connected to a node between the first switching transistor Q1t and the second switching transistor Q2t, a second terminal of the first inductor L1t is electrically connected to the positive electrode of the rechargeable battery BT1 through a first relay R1t and is also connected to the mains supply AC through a second relay R2t, a first capacitor Cp and a second capacitor Cn are connected in series between the positive direct current bus DC+ and the negative direct current bus DC−, and a node DC-mid between the first capacitor Cp and the second capacitor Cn is grounded. Similarly, the second bridge arm Y of the second phase T includes a second inductor L2t, a third switching transistor Q3t, and a fourth switching transistor Q4t, where a first terminal of the third switching transistor Q3t is electrically connected to the positive current bus DC+, a second terminal of the third switching transistor Q3t is electrically connected to a first terminal of the fourth switching transistor Q4t, a second terminal of the fourth switching transistor Q4t is electrically connected to the negative direct current bus DC−, a first terminal of the second inductor L2t is electrically connected to a node between the third switching transistor Q3t and the fourth switching transistor Q4t, and a second terminal of the second inductor L2t is electrically connected to the positive electrode of the rechargeable battery BT1 through a fourth relay R4t and is also electrically connected to the mains supply AC through a third relay R3t.

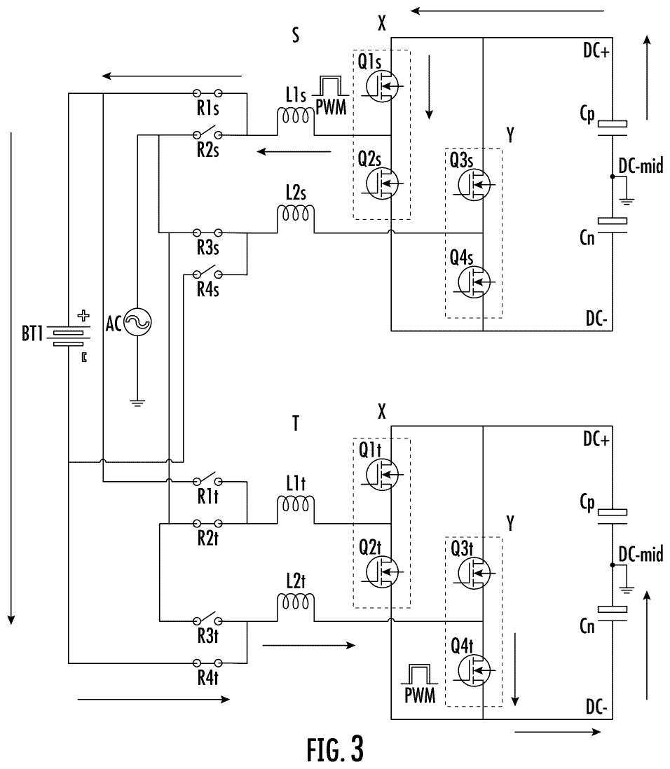

In these embodiments, the relays R1s, R3s, R2t, and R4t are switched on, the relays R2s, R4s, R1t, and R3t are switched off, the switching transistors Q1s and Q4t are controlled to be switched on, and the switching transistors Q2s and Q3t are controlled to be switched off. In this case, the current loop is: DC-mid→Cp→DC+→Q1s→L1s→R1s→BT1→R4t→L2t→Q4t→DC−→Cn→DC-mid, as shown by arrows in FIG. 3. It can be learned that in this case, DC-DC conversion is implemented through the loop formed by the first bridge arm X of the first phase S and the second bridge arm Y of the second phase T, to store energy for the inductors L1s and L2t and charge the battery BT1. In addition, in this embodiment, both the second bridge arm Y of the first phase S and the first bridge arm X of the second phase T are connected to the mains supply AC, and are disconnected from the battery BT1. Therefore, the two bridge arms constitute a rectifier bridge arm, and the mains supply supplies power to the direct current bus to implement AC-DC conversion. A rectification principle of the rectifier bridge arm is the same as that of the conventional technology, and details are not described herein again.

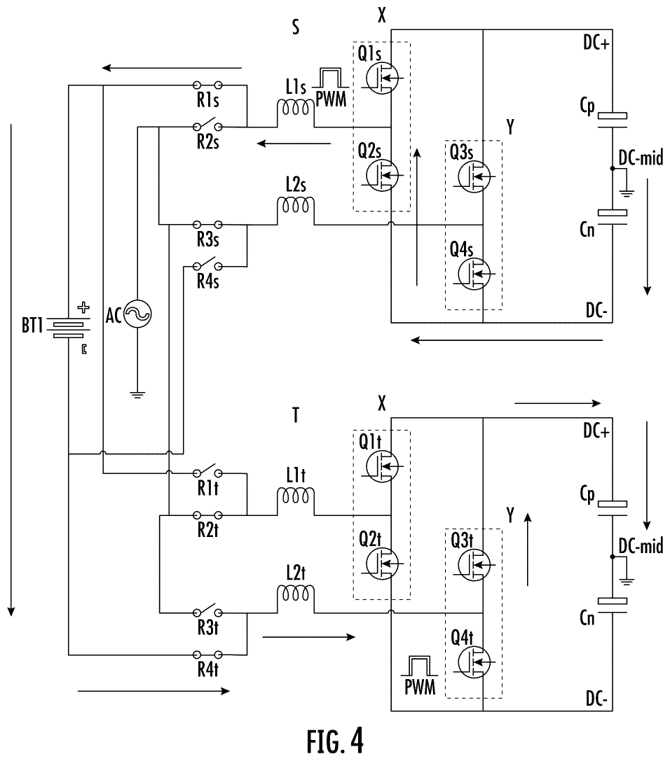

After the inductors L1s and L2t are full of energy, the switching transistors Q1s and Q4t are controlled to be switched off, and the switching transistors Q2s and Q3t are controlled to be switched on. In this case, the current loop is: DC-mid→Cn→DC−→Q2s→L1s→R1s→BT1→R4t→L2t→Q3t→DC+→Cp→DC-mid, as shown by arrows in FIG. 4. It can be learned that in this case, DC-DC conversion is implemented through the loop formed by the first bridge arm X of the first phase S and the second bridge arm Y of the second phase T, and the inductor L1s of the first bridge arm X of the first phase S and the inductor L2t of the second bridge arm Y of the second phase T release energy, to charge the battery BT1. In addition, the second bridge arm Y of the first phase S and the first bridge arm X of the second phase T constitute a conventional rectifier bridge arm to implement AC-DC conversion.

In this embodiment, when the battery BT1 needs to be charged, a part of the bridge arms of the power converter implement a rectification function, and another part of the bridge arms implement a reverse charging function.

After the battery BT1 is fully charged, the relays R1s and R4t can be controlled to be switched off, and the relays R2s and R3t can be controlled to be switched on, so that the entire power converter implements dual-phase dual-bridge arm rectification, thereby improving a rectification capability of the entire power converter.

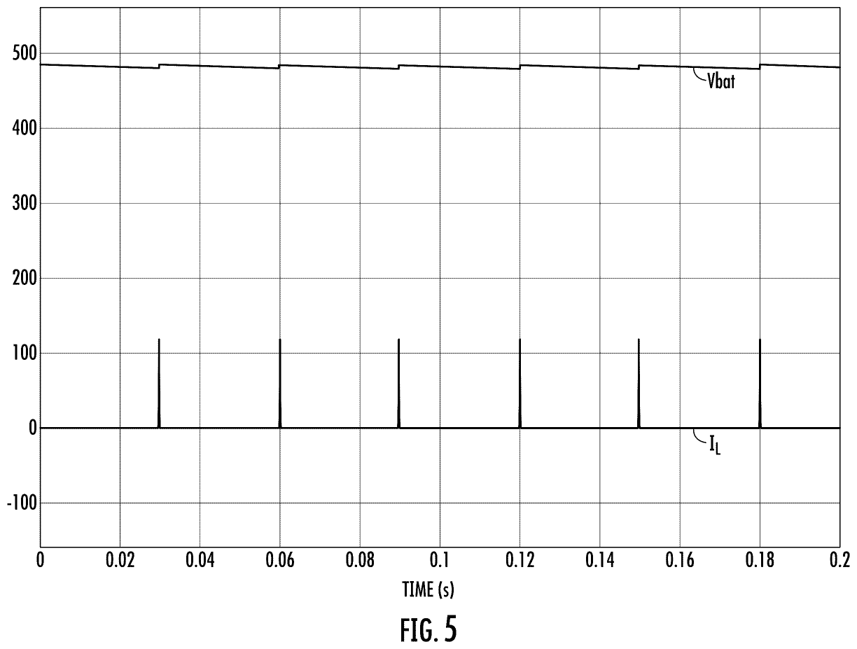

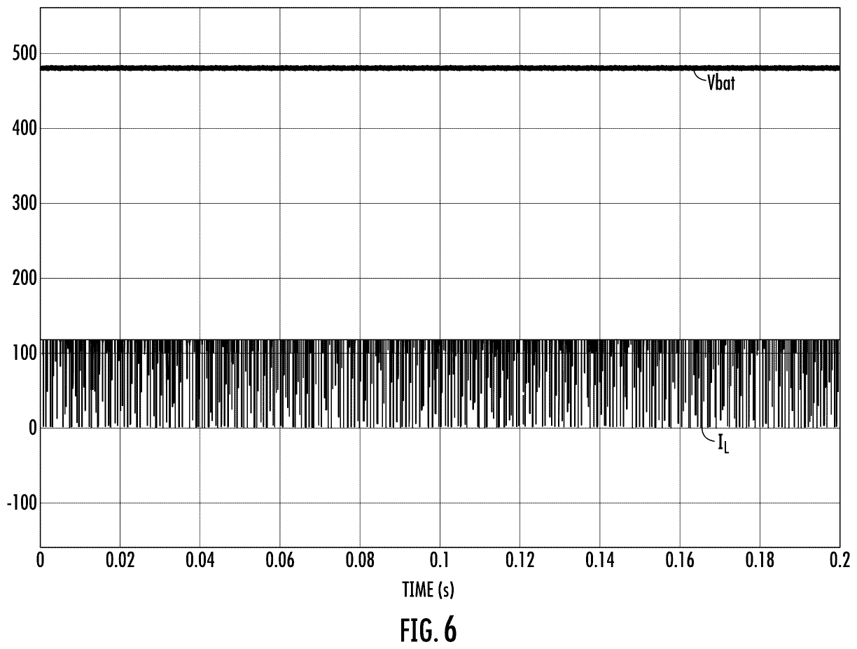

To reflect the effect of the present inventive concept, the inventor performs simulation processing on the power converter in the foregoing embodiments. Referring to curves of battery voltages and inductor circuits of a simulation experiment in FIG. 5 and FIG. 6, the battery voltage and the inductor current during charging with a small current are shown in FIG. 5, and the battery voltage and the inductor current during charging with a large current are shown in FIG. 6. It can be learned that the power converter in some embodiments of the present inventive concept can implement stable voltages at two terminals of the battery, that is, implement continuous and effective charging of the battery.

According to some embodiments of the present inventive concept, the power converter further includes a third phase R. A circuit topology of the third phase R is the same as the circuit topologies of the first phase S and the second phase T in the foregoing embodiment, and includes two bridge arms X and Y that are parallel to each other. Details are not described again. Those skilled in the art can understand that, in this embodiment, when the battery does not need to be charged, all the first phase S, the second phase T, and the third phase R operate in a rectification mode, to convert the mains supply into a direct current. When the battery needs to be charged, one bridge arm is selected from each of any two of the first phase S, the second phase T, and the third phase R and is electrically connected to the battery to charge the battery. Specifically, a current direction is the same as that in the foregoing embodiment, and the other bridge arms are used for rectification.

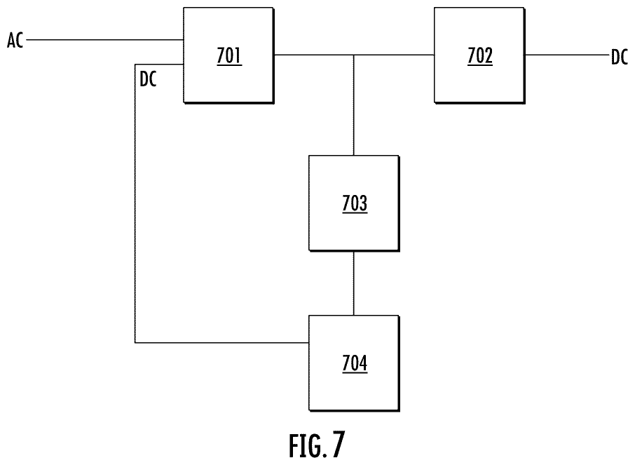

Still some embodiments of the present inventive concept provides a UPS. Referring to a structural block diagram of the UPS in these embodiments shown in FIG. 7, the UPS includes a power converter 701, an inverter 702, a DC-DC conversion module 703, and a battery module 704.

Compared with a conventional UPS, the power converter 701 of the UPS in these embodiments can further implement charging of the battery module 704 while performing rectification. A dedicated battery charging module is omitted, the volume of the UPS is reduced, and costs are saved.

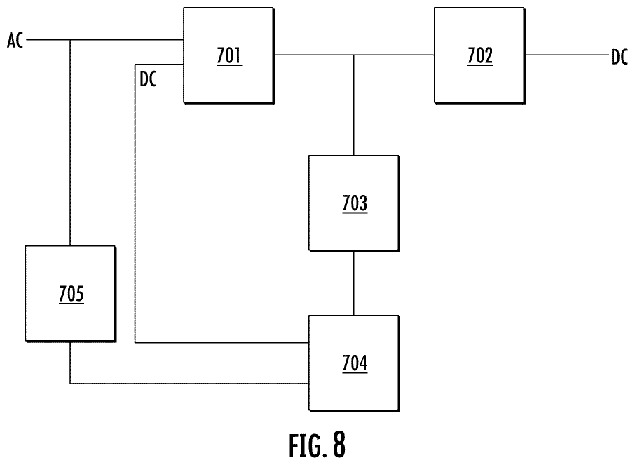

Some embodiments of the present inventive concept provides another UPS. Referring to a structural block diagram of the UPS in these embodiments shown in FIG. 8, the UPS includes a power converter 701, an inverter 702, a DC-DC conversion module 703, a battery module 704, and a charging module 705. Compared with a conventional UPS, the UPS in these embodiments can charge the battery module 704 by using both the charging module 705 and the power converter 701, thereby improving a charging capability, and is particularly applicable to a scenario in which a charging power requirement is relatively high and a load is relatively light.

Because the power converter in some embodiments of the present inventive concept can implement different operating modes by controlling relays, a UPS in these embodiments of the present inventive concept can use a full-rectification mode of the power converter when a high charging power is not required, to improve an operating capability of the load. When a high charging power is required, the UPS uses a rectification-charging mode of the power converter, to improve the charging capability. Therefore, the UPS in the present inventive concept has a wider range of application scenarios.

According to some embodiments of the present inventive concept, a relay may be replaced with a well-known switching element, including a mechanical switch, a circuit breaker, or the like. In addition, each group of switches, such as (R1s, R2s), (R3s, R4s), (R1t, R2t) and (R3t, R4t), does not have to include two separate switches, which may be replaced by a single-pole double-throw switch.

According to some embodiments of the present inventive concept, the switching transistor is an IGBT, a MOSFET, or the like.

According to some embodiments of the present inventive concept, a structure of each bridge arm is not limited to a half-bridge form in the foregoing embodiments, and may be a well-known rectifier bridge form in the art.

Although the present inventive concept has been described by using preferred embodiments, the present inventive concept is not limited to the embodiments described herein, and includes various changes and variations without departing from the scope of the present inventive concept.

What is claimed is:

1. A power converter, comprising:
a first power conversion module, comprising a first bridge arm and a second bridge arm, wherein a first terminal of the first power conversion module is configured to be capable of being electrically connected to a mains supply and/or a rechargeable battery, and a second terminal of the first power conversion module is configured to be capable of being electrically connected to a direct current bus;
a second power conversion module, comprising a third bridge arm and a fourth bridge arm, wherein a first terminal of the second power conversion module is configured to be capable of being electrically connected to the mains supply and/or the rechargeable battery, and a second terminal of the second power conversion module is configured to be capable of being electrically connected to a direct current bus; and
a switch module, configured to enable the first terminal of the first power conversion module and the first terminal of the second power conversion module to be selectively electrically connected to the mains supply and/or the rechargeable battery, wherein
the first power conversion module, the second power conversion module, and the switch module are configured to charge the rechargeable battery from the direct current bus through the first bridge arm and the fourth bridge arm.

2. The power converter of claim 1, wherein the first power conversion module, the second power conversion module, and the switch module are configured to convert a first phase of the mains supply into a direct current through the second bridge arm and provide the direct current to the direct current bus, and convert a second phase of the mains supply into a direct current through the third bridge arm and provide the direct current to the direct current bus.

3. The power converter of claim 2, wherein the switch module comprises a first switch assembly, a second switch assembly, a third switch assembly, and a fourth switch assembly that respectively correspond to the first bridge arm, the second bridge arm, the third bridge arm, and the fourth bridge arm and are separately configured to enable first terminals of the first bridge arm, the second bridge arm, the third bridge arm, and the fourth bridge arm to be selectively connected to the mains supply or the rechargeable battery.

4. The power converter of claim 3, wherein the first terminal of the first power conversion module comprises a first sub-terminal and a second sub-terminal, and the first terminal of the second power conversion module comprises a third sub-terminal and a fourth sub-terminal, wherein the first sub-terminal is electrically connected to the first switch assembly, the second sub-terminal is electrically connected to the second switch assembly, the third sub-terminal is electrically connected to the third switch assembly, and the fourth sub-terminal is electrically connected to the fourth switch assembly.

5. The power converter of claim 3, wherein the first bridge arm, the second bridge arm, the third bridge arm, and the fourth bridge arm each comprise an inductor, a first switching transistor, and a second switching transistor, wherein a first terminal of the first switching transistor and a second terminal of the second switching transistor constitute an output terminal of the bridge arm, a second terminal of the first switching transistor is electrically connected to a first terminal of the second switching transistor, a first terminal of the inductor is electrically connected to a node between the first switching transistor and the second switching transistor, and a second terminal of the inductor is electrically connected to a corresponding switch assembly.

6. The power converter of claim 1, wherein two capacitors connected in series with each other are separately disposed between a positive electrode and a negative electrode of the direct current bus, and a node between the two capacitors is grounded.

7. The power converter of claim 4, further comprising:
a third power conversion module, comprising a fifth bridge arm and a sixth bridge arm, wherein a first terminal of the third power conversion module is configured to be capable of being electrically connected to the mains supply, and a second terminal of the third power conversion module is configured to be capable of being electrically connected to the direct current bus.

8. The power converter of claim 4, comprising the following operating modes:
a rectification mode, wherein the switch module is configured to enable the first sub-terminal, the second sub-terminal, the third sub-terminal, and the fourth sub-terminal to be electrically connected to the mains supply; and
a rectification-charging mode, wherein the switch module is configured to enable the first sub-terminal and the fourth sub-terminal to be electrically connected to the rechargeable battery, and the second sub-terminal and the third sub-terminal to be electrically connected to the mains supply.

9. An uninterruptible power supply comprising a power converting, the power converter including:
an inverter, electrically connected to the direct current bus of the power converter;
a rechargeable battery, whose charging terminal is electrically connected to the switch module of the power converter; and
a DC-DC converter, configured to convert an output voltage of the rechargeable battery and then provide a converted voltage to the inverter.

10. The uninterruptible power supply of claim 9, further comprising a charger electrically connected to the charging terminal of the rechargeable battery.
